(19) United States
(12) Patent Application Publication
(10) Pub. No.: US 2024/0375027 A1
(43) Pub. Date: Nov. 14, 2024

(54) TILTABLE FILTER CANISTER

(71) Applicant: Pitco Frialator, Inc., Bow, NH (US)

(72) Inventors: Matthew Conti, Concord, NH (US); Steven J. Cyr, Bow, NH (US); Karl M. Searl, Newmarket, NH (US)

(73) Assignee: Pitco Frialator, Inc., Bow, NH (US)

(21) Appl. No.: 18/633,266

(22) Filed: Apr. 11, 2024

Related U.S. Application Data
(60) Provisional application No. 63/501,451, filed on May 11, 2023.

(51) Int. Cl. B01D 29/96; A47J 37/12; B01D 24/10; B01D 24/48

(52) U.S. Cl. CPC B01D 29/965; A47J 37/1223; B01D 24/10; B01D 24/4876; B01D 2201/347; B01D 2201/4007

(57) ABSTRACT

A tiltable filter canister including a housing and a lid adjacent to each other. The lid encloses the housing to form an interior of the tiltable filter canister. A seal may be disposed between the housing and the lid for forming a vacuum tight seal. A handle is connected to the lid, the handle having a first position and a second position. When the handle is in the first position, the seal may form the vacuum tight seal. A pin connects the handle to the lid and allows the handle to rotate between the first position and the second position. An arcuate surface may be present on the handle with a first protrusion for receiving a stop and a second protrusion. A first canister position of the tiltable filter canister is configured for performing a filtering operation and a second canister position of the tiltable filter canister is configured for performing a maintenance operation. A filtration media may be disposed within the interior of the tiltable filter canister for filtering a fluid during the filtering operation.

### CROSS-REFERENCES TO RELATED APPLICATION DATA

This application claims the benefit of U.S. Provisional Patent Application No. 63/501,451 filed May 11, 2023, the contents of which are hereby incorporated by reference in its entirety.

### FIELD OF TECHNOLOGY

The present disclosure relates generally to filtration systems for fluid heating devices such as food fryers.

### BACKGROUND

The use of heated fluids such as oil in cooking is well known. For example, a food may be cooked by placing the food into heated oil. During the cooking process, the oil may accumulate particles from the food such as fried batter or flakes of food. This particulate reduces heating efficiency by absorbing some of the heat in the oil instead of allowing the heat to transfer to the food for cooking/heating. More heat and/or oil thus becomes necessary to maintain the cooking temperature and as a result more energy or fuel may be consumed to achieve the necessary oil temperature.

Previous attempts to overcome these problems have resulted in the addition of a filter to cooking systems such as fryers. In such systems, the cooking oil is pumped or pressurized to move through the filter to remove particulate from the oil and allow for better temperature maintenance and extended use of the oil. Filters, often implemented as a separate apparatus from the fryer, allow fryers to perform more cooking cycles using temperature controlled oil by cycling the oil through the filter to clean the oil.

However, previous implementations of filters suffered from the drawback of being difficult to replace or requiring the fryer/cooking system to be offline for service for extended periods, reducing system availability.

SUMMARY

The present disclosure provides an improved implementation of a filter in a filter canister to achieve increased filter accessibility for changing the filter, and a method of replacing the filter to achieve system maintenance efficiencies. A tiltable filter canister is configured for enclosing the filter used with a cooking system, such as a fryer.

The tiltable filter canister comprises a tiltable housing and a lid disposed adjacent to the tiltable housing and enclosing an interior of the filter canister. A seal is disposed between the tiltable housing and the lid. A handle is connected to the lid, and the handle is moveable between a first position and a second position. When the handle is in the first position the seal forms a vacuum tight seal of the filter canister. A connection point, e.g., a pin on opposite sides of the handle, connects the handle to the lid, and allows the handle to rotate between the first position and the second position. The opposed sides of the handle each comprise an arcuate surface, with each having a recess for receiving a stop on the lid when the handle is in the first position. The arcuate surface acts as a cam surface when the handle is moved from the first position to the second position. The arcuate surface ends at an abutment surface against which the stop abuts when the handle is in the second position. When the tiltable filter canister is in a first canister position of the tiltable housing, wherein the handle is in the first position, a filtering operation may be performed. When the tiltable filter canister is in a second canister position of the tiltable housing, wherein the handle is in the second position, the lid may be removed and a maintenance operation may be performed. A filtration media may be disposed within the interior of the tiltable housing to filter fluid during the filtering operation.

The tiltable filter canister of the present disclosure provides the tiltable housing for storing a filtration media such as a fabric filter, the housing having an inlet for receiving a fluid to be filtered, and an outlet for the filtered fluid to exit the tiltable filter canister. The lid covers a hollow space within the tiltable filter canister and encloses the filtration media therein. A seal such as an O-ring or a gasket may be used to seal the canister and ensure a substantial vacuum can be facilitated, and any fluid is retained within the tiltable filter canister during filtration.

As fluid is filtered through the filtration media within the tiltable filter canister, particulates such as food crumbs accumulate on the filtration media. Once the filtration media has filtered the fluid, e.g., fryer oil, for some period, the filtration media needs to be replaced. The vacuum within the tiltable filter canister may be eliminated or broken, by actuation of the handle moving the cam surface along a portion of the stop to unseal the tiltable filter canister, and the tiltable filter canister can be tilted for removal or access to perform a maintenance operation such as change out the filtration media or otherwise service the filter system.

To gain access to the interior of the tiltable filter canister, the handle may be actuated from the first position to the second position. Actuation of the handle may cause the vacuum tight seal between the lid and the housing to break via engagement of the cam surface against the stop. In an embodiment, actuation of the handle may result in a signal being sent when the handle is out of the first position, the signal indicating that the vacuum tight seal has been broken and signaling that the fluid may be pumped from within the tiltable filter canister in a purge operation. A signal to purge the fluid from inside the tiltable filter canister's housing may be sent to a pump to pump the fluid from the tiltable filter canister.

Once the purge operation has been completed, the lid may be removed from the housing to provide access to the filtration media. The filtration media may be replaced and/or the tiltable filter canister may be otherwise serviced, e.g., the interior of the housing may be cleaned, or a blockage in the housing may be cleared, or the like. The lid may be re-placed on the housing and the handle may be actuated to the first position to form the vacuum tight seal between the lid and the housing.

To perform the maintenance operation the tiltable filter canister may be moved from a first canister position to a second canister position by tilting or rotating the tiltable filter canister. After the maintenance operation is complete, the tiltable filter canister may be moved from the second canister position to the first canister position to resume filtering operations. With the tiltable filter canister returned to the first position, fluid may be pumped through the system from a tank and the filtering operation may commence. The tiltable filter canister may be connected in the system using a quick disconnect fitting to allow toolless removal of the canister and toolless filtration media replacement. The filtration media may be changed daily and the filter housing may undergo monthly maintenance while minimizing the down time of the fryer. The tiltable filter canister may be positioned on a rotatable, quick-release interconnection to enable tilting or rotation of the tiltable filter canister from the first canister position to the second canister position and vice versa.

By way of example, a fryer is described using an embodiment of the tiltable filter canister. However, a person of ordinary skill in the art would understand that the present disclosure may be adapted for use with various other devices within and outside of the cooking industry. The tiltable filter canister may be used as described with any of various devices requiring the use of a filtration media that requires replacement or service.

The above summary has outlined, rather broadly, some features and advantages of the present disclosure in order that the detailed description that follows may be better understood. Additional features and advantages of the disclosure will be described below. It should be appreciated by those skilled in the art that this disclosure may be readily utilized as a basis for modifying or designing other structures/processes/steps for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization, method of operation, or resultant product, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1A illustrates a side view of an embodiment of the tiltable filter canister in a fryer assembly.

FIG. 1B illustrates a perspective view of the illustrative embodiment of the tiltable filter canister of FIG. 1A.

FIG. 1C illustrates a side view of a top portion of the illustrative embodiment of the tiltable filter canister of FIG. 1B.

FIG. 2 illustrates a top perspective view of an embodiment of the tiltable filter canister with the lid removed for a maintenance operation.

FIG. 3 illustrates a perspective view of an embodiment of the tiltable filter canister in an embodiment of a fryer assembly according to the disclosure.

FIG. 4A illustrates a first side view of an embodiment of a tiltable filter canister in a first canister position (substantially vertical) according to the disclosure.

FIG. 4B illustrates a second side view of the embodiment of the tiltable filter canister in a second canister position (tilted) according to the disclosure.

FIG. 5 illustrates a front perspective view of the embodiment of the tiltable filter canister in an embodiment of the fryer assembly in the second canister position according to the disclosure.

FIG. 6 is a block diagram illustrating a method of installing or replacing a filtration media using the embodiment of the tiltable filter canister of FIG. 1.

FIG. 7 is a flow diagram of a fluid filtering flow path through an embodiment of the tiltable filter canister according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

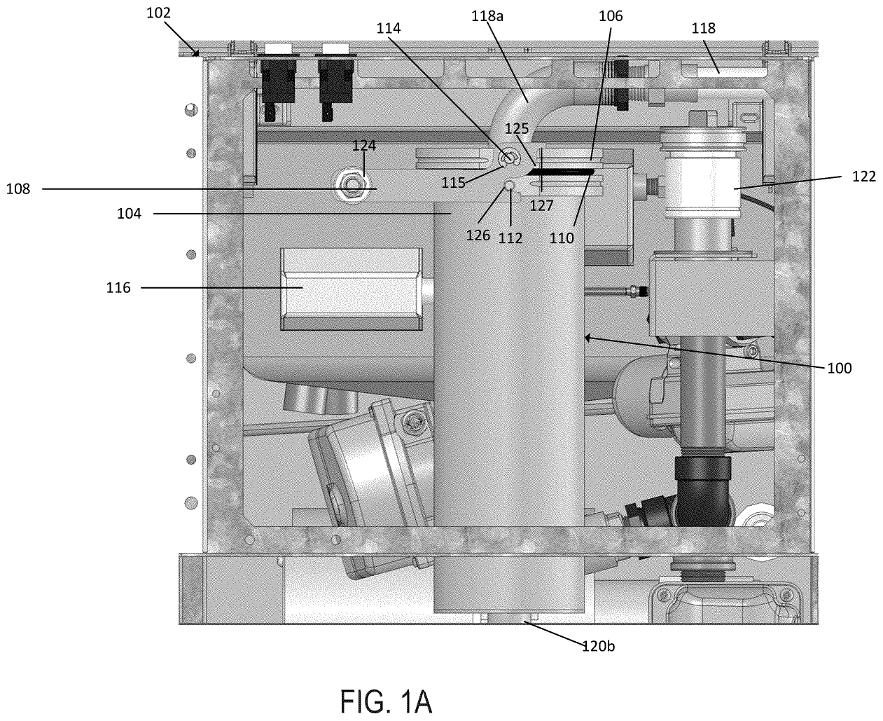

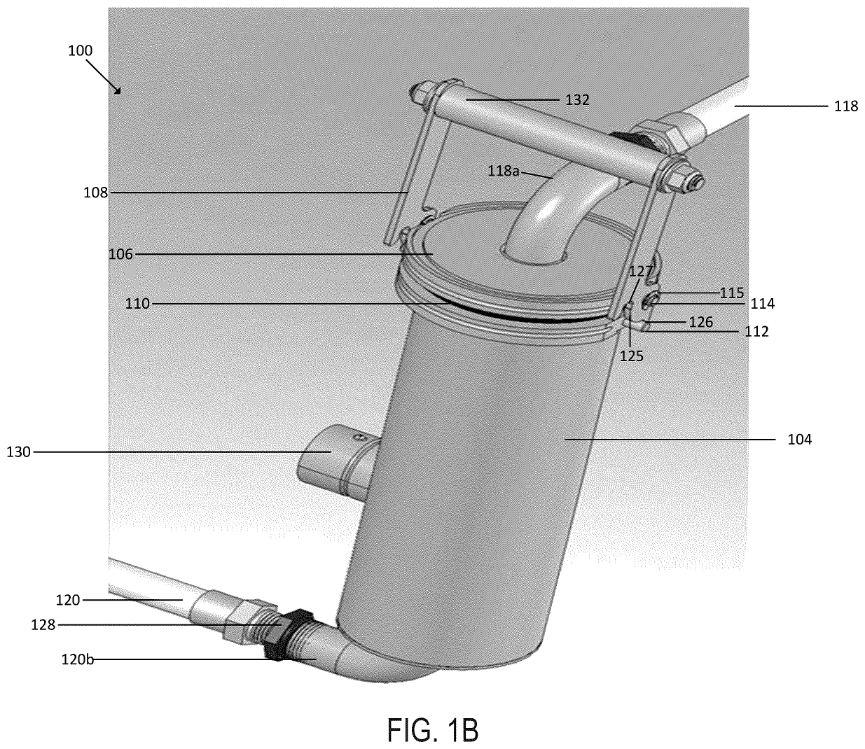

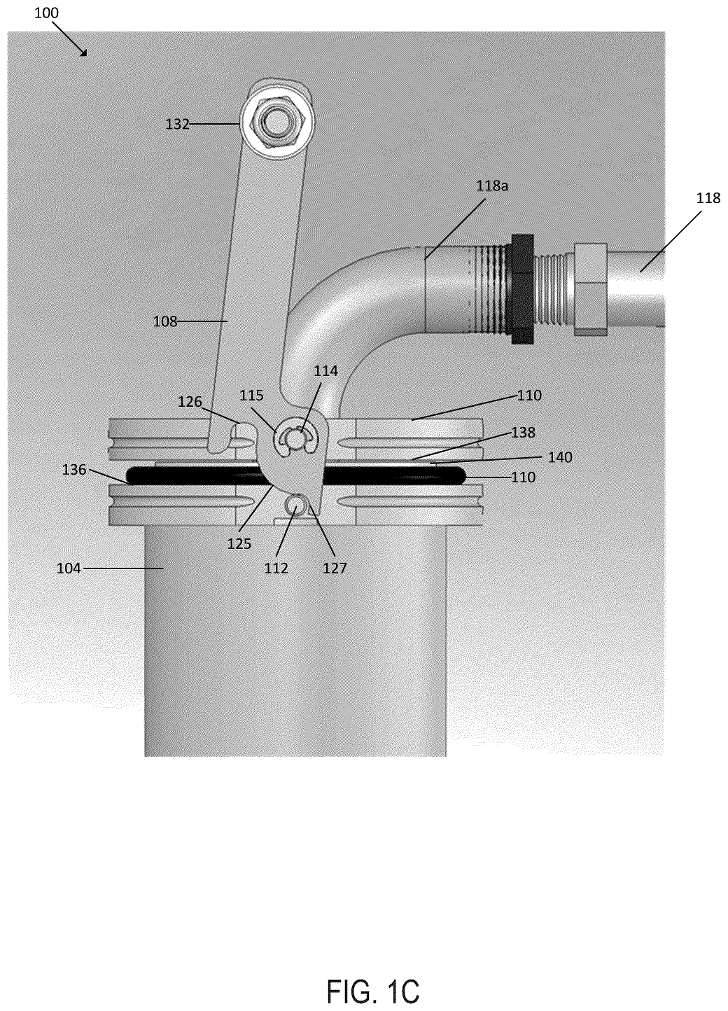

FIG. 1A illustrates a side view of an embodiment of the tiltable filter canister 100 in a filter assembly 102. The tiltable filter canister 100 includes a housing 104 and a lid 106. Between the housing 104 and the lid 106, a seal 110 may be placed for forming a vacuum tight seal between the housing 104 and the lid 106. A handle 108 may be in a first position 124, as shown, for sealing the housing 104 and the lid 106 during operation of the tiltable filter canister 100. The handle 108 is moveable between the first position 124 (as seen in FIG. 1A), and a second position (as seen in FIGS. 1B and 1C). When the handle 108 is in the first position 124 the seal may form a vacuum tight seal of the filter canister 100.

Opposite sides of the handle 108 are connected to connection points, e.g., a pin 114, in this embodiment disposed on opposite sides of the lid 106. A spring clip or retaining ring 115 may be used to connect the handle 108 to the lid 106 at the pins 114, one on each side of the canister 100, and allows the handle 108 to rotate between the first position 124 and the second position. The opposite sides of the handle each comprise an arcuate surface or cam 125, with each side having a recess 126 for receiving a stop 112 when the handle is in the first position, and the arcuate surface 125 having an abutment surface 127 against which the stop 112 abuts when the handle is in the second position (best seen in FIGS. 1B and 1C). As the handle 108 is moved from the first position to the second position, the cam surface 125 engages a top portion of the stop 112. As the cam surface 125 travels across the stop 112 the cam assists with lifting of the lid 106 from the housing 104 to break the vacuum seal.

When the tiltable filter canister 100 is in a first canister position of the tiltable housing (substantially vertical), wherein the handle is in the first position, a filtering operation may be performed. When the tiltable filter canister is in a second canister position (tilted) of the tiltable housing, wherein the handle is in the second position, a maintenance operation may be performed. A filtration media may be disposed within the interior of the tiltable housing to filter fluid during the filtering operation. The handle 108 may rest against the stop 112, with the stop 112 engaged in the recess 126, when in the first position 124 wherein the vacuum tight seal is formed. The handle 108 may be rotated around the pin 114 to move from the first position 124 to the second position (132 shown in FIGS. 1B-1C) for breaking the vacuum tight seal and accessing the filtration media (not shown) within the housing 104.

Generally, during operation of the filter assembly 102, a fluid (e.g., cooking oil) may flow into the filtration media in the housing 104 of the tiltable filter canister 100 via a tank valve 116 connected to a fitting on a tank (not shown). It should be appreciated that any of various rotatable quick disconnects could be implemented as the tank valve 116 or a quick disconnect fitting 130 (best seen in FIG. 1B) as described herein, such as a ⅛^{th} turn quick disconnect by Gemini Valve of Raymond, NH. The tank valve 116 may include a one-way valve to prevent backflow during a filtering operation. The fluid may flow through the filtration media and out of the interior of the tiltable filter canister 100 through a filter connection 118a to a filter line 118 during the filtering operation. The fluid may flow through a purge connection 120b to a purge line (120 shown in FIG. 1B) connected by a purge disconnect 128 during a purge operation. During the purge operation, fluid in the tiltable filter canister 100 may be pumped out of the tiltable filter canister 100 through the purge line 120, so that the tiltable filter canister 100 is substantially empty for access to the filtration media and interior of the tiltable filter canister 100.

Over time, as the filtration media filters particulates from the fluid, it will need to be changed, or the tiltable filter canister 100 otherwise serviced. The inflow of fluid to the tiltable filter canister 100 may be interrupted by disconnecting the tank valve 116. Disconnecting the tank valve 116 from a quick disconnect fitting 130 may close a one-way valve in the tank valve 116 to prevent further flow of the fluid from the tank.

A strainer 122 may be included in the filter assembly 102. The strainer 122 may be located inline to the fluid flow path to filter the fluid while the tiltable filter canister undergoes the purge operation. Additionally, the strainer 122 may provide additional filtering of particulates from the fluid during the filtering operation.

As illustrated in FIG. 1B, the tiltable filter canister 100 further includes the quick disconnect fitting 130 (e.g., the ⅛^{th} turn quick disconnect by Gemini Valve of Raymond, NH), having a rotation mechanism that allows the tiltable filter canister 100 to rotate as described herein about the tank valve (116 shown in FIG. 1A). The quick disconnect fitting 130 also allows the tiltable filter canister 100 to be disconnected from the filter assembly 102. It should be appreciated that the quick disconnect fitting 130 may be any of various fittings, e.g., that allow rotation of up to a ½ turn (180 degrees).

FIG. 1C illustrates a side view of a top portion of an illustrative embodiment of the tiltable filter canister 100 according to the disclosure. The housing 104 may include an extension 140 extending towards the lid 106 with a housing lip 136 for receiving the seal 110. In this illustration, the handle 108 is shown in the second position 132 with substantially no pressure on the seal 110 and no vacuum tight seal formed between the housing 104 and the lid 106. The handle 108 may be used to lift the lid 106 away from the opening of the housing 104 for access to filtration media within the housing 104.

The handle 108 may be secured to the lid 106 with a pin 114 and held in place with the retaining rings 115 on the pin 114. The handle 108 may rotate about the pin 114, with the cam surface (125 discussed hereinbefore) engaging the stop 112 to assist in breaking the vacuum, until the abutment surface 127 reaches the stop 112, so the handle is fully in the second position.

When the handle 108 is in the first position 124, shown and described in relation to FIG. 1A, the stop 112 is fully engaged within the recess 126 to form a catch for the stop 112 to rest within and retain the handle 108. As a result, the handle may be retained in the first position 124 during a filtering operation. In the first position 124, the housing lip 136 may be proximate to a lid lip 138 with the seal 110 pressed between the surface of the housing lip 136 and the lid lip 138. A vacuum tight seal may be formed to retain a fluid in the tiltable filter canister 100 during operation.

The handle 108 may be actuated from the first position (shown as 124 in FIG. 1A) to the second position (shown as 132 in FIG. 1B and 1C). As the handle 108 rotates about the pin 114, the arcuate surface 125 travels along the stop 112 of the handle 108. The handle's rotation may release the vacuum tight seal and move the housing lip 136 away from the lid lip 138 releasing pressure on the seal 110.

When the handle 108 is in the second position 132 the abutment surface 127 may rest against the stop 112. In this position, the housing lip 136 may be releasable from the lid lip 138 with the seal 110 resting/positioned on the surface of the housing lip 136 or the lid lip 138. The handle 108 in the second position 132 may be used to remove the lid 106 from the tiltable filter canister 100 and expose an interior (not shown) of the housing 104 for access to a filtration media within the tiltable filter canister 100.

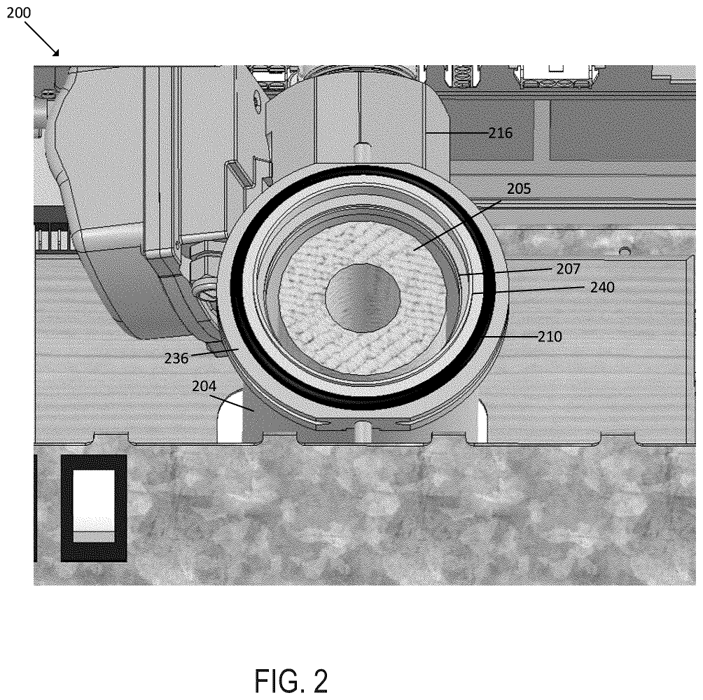

FIG. 2 illustrates a top perspective view of an embodiment of the tiltable filter canister 200 with the lid moved/removed, e.g., for a maintenance operation. The tiltable filter canister 200 includes a housing 204 enclosing a housing interior 207. Filtration media 205 may be installed within the housing interior 207. The housing 204 may include an extension 240 extending towards a lid (such as 106 in FIGS. 1A-1C) with a housing lip 236 for receiving a seal 210. Generally, during operation of the tiltable filter canister 200, a fluid (e.g., cooking oil) may flow into the filtration media 205 in the interior 207 of the housing 204 of the tiltable filter canister 200 via a tank valve 216 connected to a fitting on a tank (not shown). It should be appreciated that any of various rotatable quick disconnects could be implemented as the tank valve 216 or a quick disconnect fitting (such as 130 in FIG. 1B) as described herein, such as a ⅛^{th} turn quick disconnect by Gemini Valve of Raymond, NH. The tank valve 216 may include a one-way valve to prevent backflow during a filtering operation. The fluid may flow through the filtration media and out of the interior 207 of the tiltable filter canister 200 as described herein with respect to the filtering operation and the purge operation respectively.

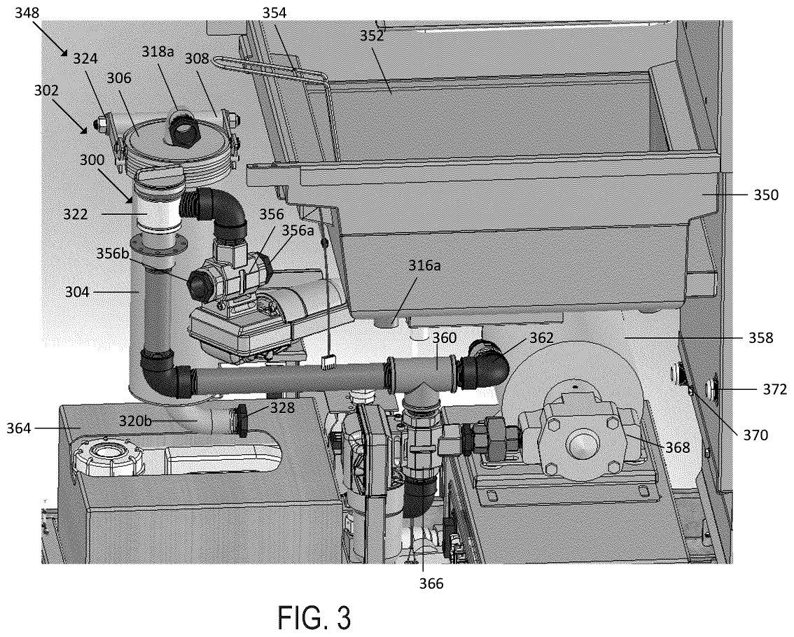

FIG. 3 illustrates a perspective view of an embodiment of the tiltable filter canister 300 in a filter assembly 302 according to the disclosure. The filter assembly 302 may be installed in a cooking implement such as a fryer 348. A tank 350 of the fryer 348 may contain a fluid 352 such as cooking oil for cooking a food item located in a fryer basket 354. The tank 350 may be in fluid communication with the filter assembly 302 via a tank valve (116 shown in FIG. 1A). A tank line (not shown) attached to a tank connection 316a may connect the tank in fluid communication with the filter assembly 302. The filter assembly 302 may include a tiltable filter canister 300 and a strainer 322, as described hereinbefore. A diversion valve 356 may be located between the tiltable filter canister 300 and the strainer 322.

During a filtering operation, the fluid, e.g., fryer oil, 352 may flow from the tank 350 out the tank fitting 316a connected to a tank valve (such as tank valve 116 shown in FIG. 1A) and into the tiltable filter canister 300. The fluid 352 may enter the tiltable filter canister 300 and be filtered through filtration media inside the housing 304 of the tiltable filter canister 300. During the filtering operation, the fluid 352 may flow out of the tiltable filter canister 300 through a filter connection 318a.

The tiltable filter canister 300 may be emptied via a purge operation, wherein a pump 358 in the fryer 348 may be used for draining the tiltable filter canister 300. The pump 358 may exert a vacuum force through the diversion valve 356 on the purge line 320b to drain fluid 352 from inside the tiltable filter canister 300. The tank valve (such as tank valve 116 in FIG. 1A) may close for the duration of the purge operation to prevent draining the fluid 352 from the tank 350. After the purge operation is complete, the tiltable filter canister 300 may be moved to a second position for maintenance. A purge disconnect 328 may be disconnected to remove the tiltable filter canister 300 from the fryer 348.

A lid 306 may enclose the interior of the housing 304 and form a vacuum tight seal against the housing as described hereinbefore. A handle 308, as described hereinbefore with respect to FIGS. 1A-1C, may be used to form or break the vacuum tight seal. The handle 308, shown in a first position 324, may press or otherwise seal the lid 306 against the housing 304. The vacuum tight seal ensures the fluid remains pressurized inside the tiltable filter canister 300 during operation. The handle may include an arcuate surface (for example as shown and described with respect to FIGS. 1A-1C) with a recess that receives a stop for retaining the handle in the first position and maintaining the vacuum tight seal.

A fluid reservoir 364 such as a “jug-in-box” (“JIB”) may be connected to the fluid flow path for adding fluid to the system if the fryer 348 detects the fluid level in the tank 350 is low. The fluid reservoir 364 may be connected to a fill valve 366 for directing fluid from the fluid reservoir 364 into the fluid flow path. The added fluid may join the filtered fluid from the filter assembly 302 and flow to the pump 358. If the fluid 352 is not at a predetermined temperature, it may need to be heated by a heat source such as a burner in a heat exchanger (not shown). The pump 358 may direct the fluid 352 from a pump outlet 368 to a heat exchanger inlet 370. The fluid 352 may be exposed to the heat source and raised to the predetermined temperature. The fluid 352 may be directed from a heat exchanger outlet 372 to the tank 350. GOT TO HERE

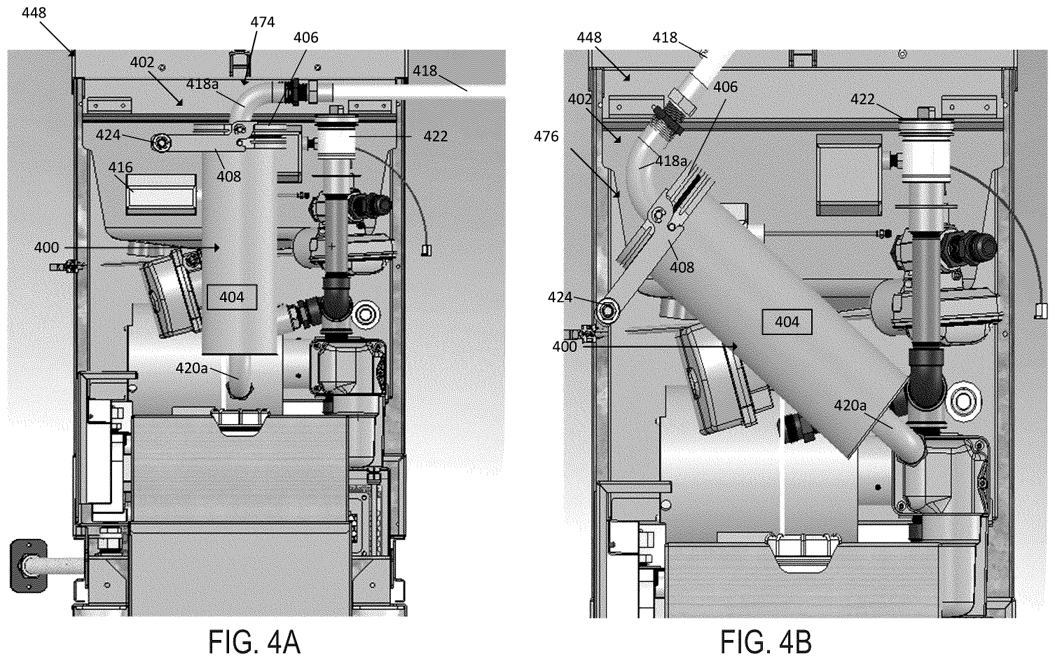

FIG. 4A illustrates a first side view of an embodiment of a tiltable filter canister 400 in a first canister position 474 according to the disclosure. A filter assembly 402 including the tiltable filter canister 400 may be installed in a cooking implement such as a fryer 448. The tiltable filter canister 400 is in the first canister position 474 (substantially vertical) during filtering operation. The tiltable filter canister 400 may include a housing 404 and a lid 406 to form an enclosed interior (not shown in FIG. 4A or 4B, but discussed hereinbefore with respect to FIG. 2) of the tiltable filter canister 400. A handle 408 is in a first position 424 during the filtering operation to maintain a vacuum tight seal between the housing 404 and the lid 406. A tank valve (not shown) may be connected to a tank (not shown) for directing a fluid from the tank to the filter assembly 402. A filter connection 418a may be connected to the lid 406, connecting the canister 400 to a filter line 418. A purge connection 420a may be connected to the housing 404 for connecting to a purge line (such as purge line 120 shown in FIG. 1A).

Filtration media within the tiltable filter canister 400 may be used to filter the fluid and remove particulates. When the filtration media is to be replaced, or the filter canister otherwise serviced such as for cleaning, the tiltable filter canister 400 may be tilted, as shown in FIG. 4B, to provide access to the tiltable filter canister 400 and its interior.

The tilted tiltable filter canister 400 shown in FIG. 4B illustrates a second side view of the embodiment of the tiltable filter canister 400 in a second canister position 476 according to the disclosure. In an embodiment, the tiltable filter canister may rotate either clockwise or counter-clockwise (corresponding to a forward tilt and a return-to-vertical-no-tilt), from the first canister position 474 to the second canister position 476. The tiltable filter canister may rotate about the tank valve and a quick disconnect fitting (such as tank valve 116 and quick disconnect fitting 130 shown in and discussed with respect to FIGS. 1A-1B).

In an embodiment, the rotation of the tiltable filter canister 400 may be from zero degrees) (0°) to approximately forty-five degrees (45°) from the substantially vertical position. The tiltable filter canister 400 may be rotated via the quick disconnect fitting, as illustrated in FIG. 1B and described with respect thereto (as discussed, the tiltable filter canister further includes a quick disconnect fitting, so that the canister may rotate as described herein), and be disconnected from the fryer assembly. Although a ⅛^{th} turn quick disconnect available from Gemini Valve of Raymond, NH is described, it should be appreciated that any of various quick disconnects could be implemented as the tank valve and/or the quick disconnect fitting, to provide a tilting connection facilitating access to the interior of the tiltable filter canister 400 when the tiltable canister is tilted and the handle is actuated to the second position. The tiltable filter canister 400 may be rotated to any of various angles without departing from the disclosure. For example, in an alternative embodiment, a ½ turn quick disconnect fitting may be used for rotating the tiltable filter canister 400 from zero degrees (0°) to approximately one-hundred-eighty degrees (180°) from the substantially vertical position.

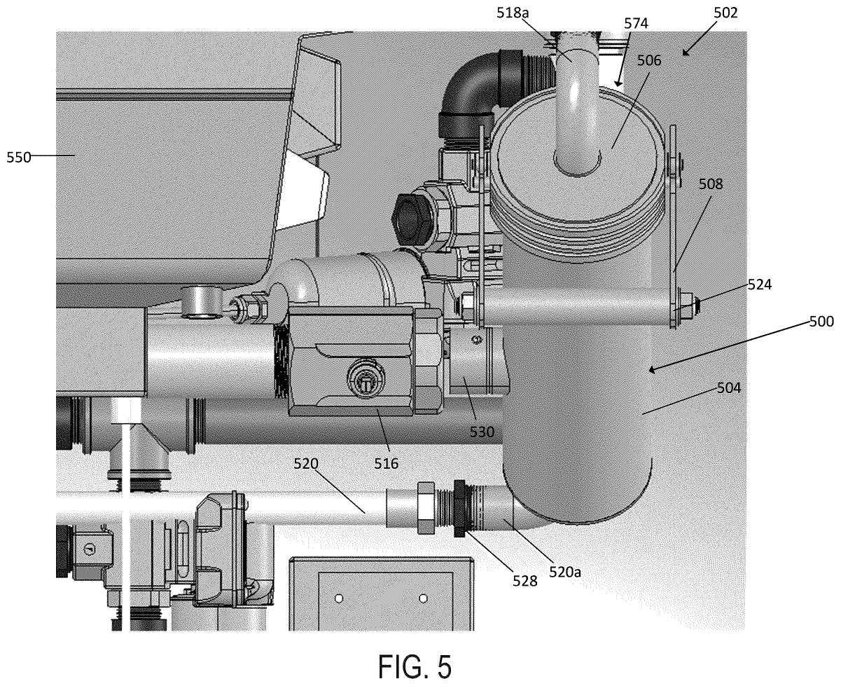

FIG. 5 illustrates a top perspective view of the embodiment of a tiltable filter canister 500 in an embodiment of a filter assembly 502 according to the disclosure. The tiltable filter canister 500 may be connected to a tank 550 using a tank valve 516. A quick disconnect fitting 530 may connect the tank valve 516 to the tiltable filter canister 500. As described herein, any of various quick disconnect solutions could be implemented to provide a tilting connection via a quick disconnect fitting, so that the canister may rotate as described herein, and be disconnected from the fryer assembly. The quick disconnect fitting 530 may be used to disconnect the tiltable filter canister 500 from the tank valve 516 prior to moving the tiltable filter canister 500 from the first canister position 574 to the second canister position (such as second canister position 476 shown in FIG. 4B). A purge connection 520a may be connected with a purge disconnect 528 to a purge line 520 to drain fluid from within the tiltable filter canister 500 prior to changing the filtration media or performing other service on the tiltable filter canister 500.

Maintenance personnel may operate the quick disconnect fitting 530 and separate the tiltable filter canister 500 from the tank valve 516. In an embodiment, the tiltable filter canister 500 may be rotated or moved to the second canister position to release the quick disconnect fitting 530 from the tank valve 516. A purge disconnect 528 may disconnect the purge line 520 from the purge connection 520a to remove the tiltable filter canister from the filter assembly 502 for maintenance. Maintenance can include replacing the filtration media within the housing 504 once a day or periodically when the filtration media may need to be replaced. Maintenance may also include cleaning the interior of the tiltable filter canister 500 when needed, for example once a month as part of routine maintenance. In an embodiment, the filtration media within the housing 504 may be replaced by removing the lid 506 from the tiltable filter canister 500 while the tiltable filter canister 500 is in the first position 574.

The tiltable filter canister 500 enables service of the filter assembly 502 quickly and while reducing the required downtime of prior systems. The rotation of the tiltable filter canister 500 allows for easier access to the interior of the tiltable filter canister 500 and the vacuum tight seal ensures liquid is retained within the tiltable filter canister 500, and the system is appropriately pressurized, during filtering operation. When the handle 508 is moved out of the first position 524, a purge operation may be used to drain fluid in the tiltable filter canister 500 out through the purge line 520 to remove fluid from the interior of the tiltable filter canister 500.

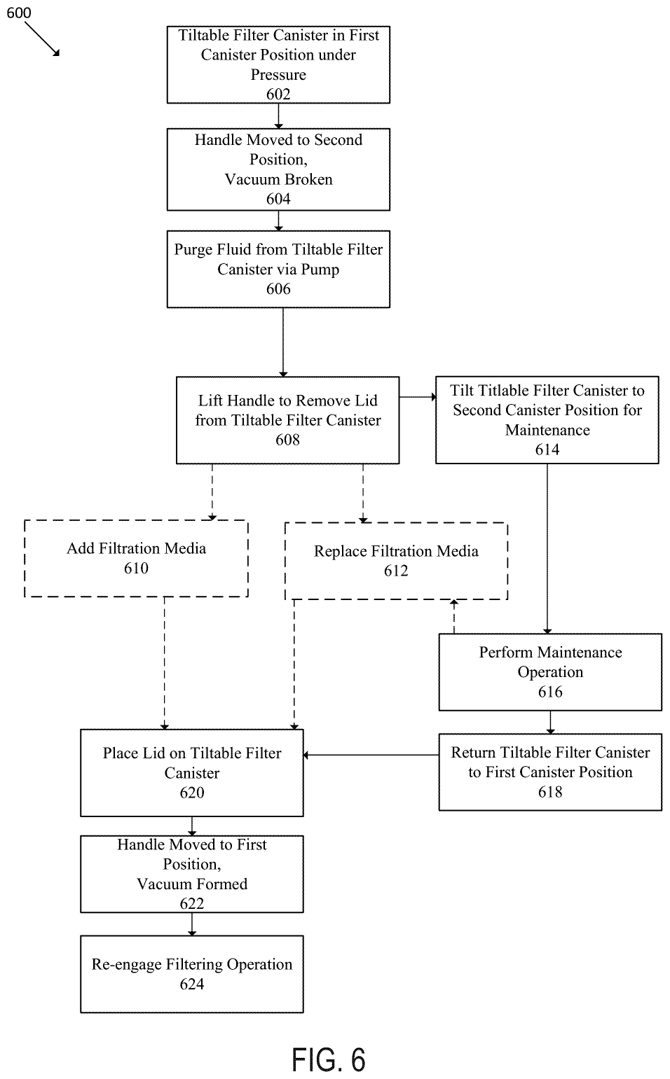

FIG. 6 is a block diagram illustrating a method 600 of performing maintenance of the tiltable filter canister of FIGS. 1-5. A tiltable filter canister according to the disclosure may be in a first canister position under pressure 602. To perform maintenance on the tiltable filter canister, the tiltable filter canister handle may be moved to a second position and a vacuum tight seal may be broken 604. Fluid is drained or purged from the tiltable filter canister by pumping the fluid out of the canister using a pump 606. The tiltable filter canister may be maintained either in the first canister position, such as for replacing the filtration media, or in the second canister position, such as for cleaning an interior of the tiltable filter canister.

The canister handle may be lifted to remove the lid from the tiltable filter canister and provide access to the interior of the tiltable filter canister 608. With the tiltable filter canister in the first position, filtration media may be added 610 or replaced 612 in the tiltable filter canister. The tiltable filter canister may be tilted or rotated to a second canister position for undergoing maintenance 614. A maintenance operation may be performed 616 on the tiltable filter canister, such as cleaning particulates, e.g., clumps of batter, pieces of food from the interior of the tiltable filter canister or replacing a filtration media 612.

Referring still to FIG. 6, the tiltable filter canister may be returned to the first canister position 618. The handle may be moved to the first position, pressing the housing lip and the lid lip towards each other and squeezing the seal to form a vacuum tight seal. Once the vacuum tight seal is formed, the tiltable filter canister may be pressurized to have the fluid vacuum formed 622 in the fluid system. Thereafter, a filtering operation using the tiltable filter canister may be re-engaged 624.

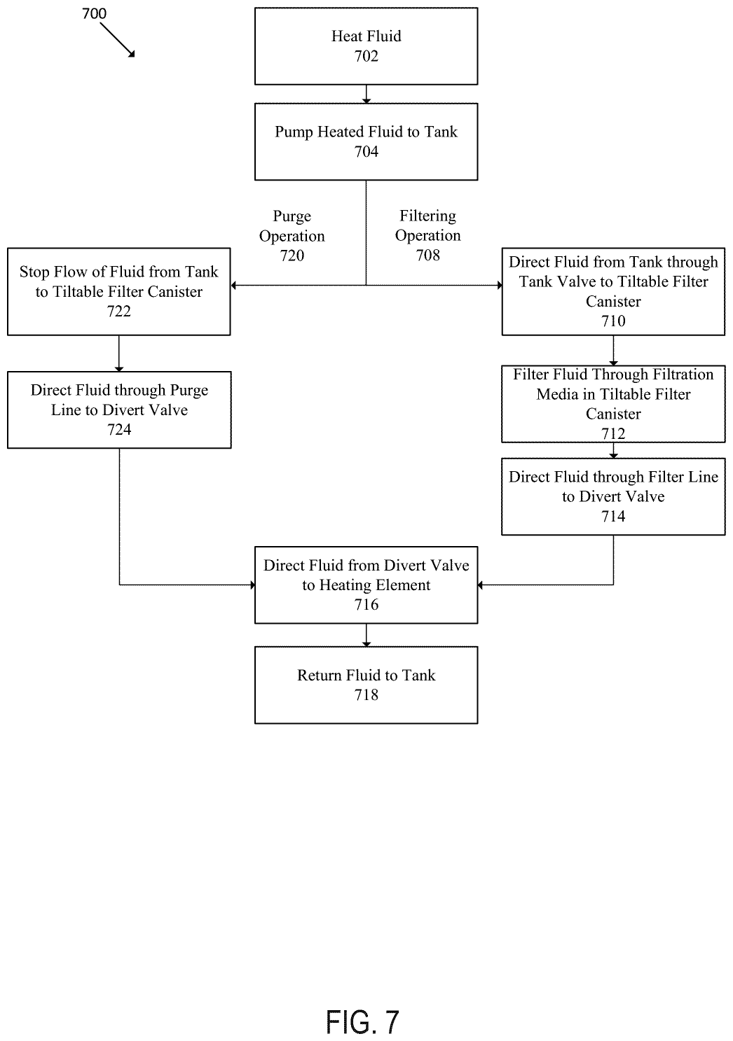

FIG. 7 is a flow diagram of a fluid filtering flow path through an embodiment of the tiltable filter canister according to the disclosure. A filter assembly in a fryer may be located in a fluid flow path 700. The fluid, such as a cooking oil, may be heated 702 to a predetermined temperature using a heating element such as a heat exchanger or burner known in the art. The fluid may be pumped 704 from the heating element to a tank in the fryer. During cooking of a food item, the fluid may accumulate particulates, e.g., clumps of batter, pieces of food.

During a filtering operation 708, the fluid may be directed from the tank to the tiltable filter canister using a tank valve 710. The fluid may be filtered through filtration media in the tiltable filter canister 712. The filtered fluid may be directed through a filter line to a divert valve 714. The fluid may be directed to the heating element 716 for raising the fluid to the predetermined temperature. Once the fluid is at the predetermined temperature, the fluid is directed to the tank 718 to continue cooking the food item. A person of ordinary skill in the art will understand that the flow path may be continuous such that fluid is flowing into and out of the tank at a sufficient rate to maintain an approximately level amount of fluid in the tank during operation. As part of this continuous flow, the filter assembly may be constantly filtering the fluid as it passes through the filtration media.

During a purge operation 720, i.e., to substantially empty the filter housing of fluid, fluid flow from the tank to the tiltable filter canister may be stopped 722. For example, in an embodiment a tank valve may include a one-way valve which can be shut to stop flow from the tank to the tiltable filter canister 722 during the purge operation 720. The fluid in the tiltable filter canister may be drained and directed through a purge line to a divert valve 724. The purged fluid may be directed to the heating element 716 before returning to the tank 718.

A person of ordinary skill in the art would appreciate that although the embodiments illustrated in the figures shows a handle, with various physical features operating as described, the handle may be replaced with other elements for removing the lid from the housing, such as a lever, ratchet, or the like, without departing from this disclosure.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used herein, specify the presence of stated features, steps, operations, elements, and/or components, but do not preclude the presence or addition of one or more other features, steps, operations, elements, components, and/or groups thereof.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A filter canister comprising:
a tiltable housing;
a lid disposed adjacent to the tiltable housing and enclosing an interior of the filter canister;
a seal disposed between the tiltable housing and the lid;
a handle connected to the lid, the handle being moveable between a first position and a second position, when the handle is in the first position the seal forms a vacuum tight seal of the filter canister;
a connection point connecting the handle to the lid, the connection point allowing the handle to rotate between the first position and the second position;
an arcuate surface on the handle with a first recess for receiving a stop when the handle is in the first position, and the arcuate surface having an abutment surface against which the stop abuts when the handle is in the second position;
a first canister position of the tiltable housing wherein the handle is in the first position and a filtering operation is performed;
a second canister position of the tiltable housing wherein the handle is in the second position and a maintenance operation is performed; and
a filtration media disposed within the interior of the tiltable housing to filter a fluid during the filtering operation.

2. The filter canister of claim 1, wherein the connection point is a pin.

3. The filter canister of claim 1, further comprising a filter connection connected to the lid of the filter canister and a purge connection connected to the housing of the filter canister.

4. The filter canister of claim 3, further comprising a rotatable interconnection connecting the filter canister and the purge connection.

5. The filter canister of claim 4, wherein the tiltable housing is pivotable about the rotatable interconnection between a first housing position and a second housing position.

6. The filter canister of claim 4, wherein the rotatable interconnection is a quick disconnect fitting.

7. The filter canister of claim 1, further comprising an inlet for receiving a fluid to be filtered and an outlet for a filtered fluid to exit the filter canister.

8. A filter canister comprising:
a tiltable housing;
a lid disposed adjacent to the tiltable housing, the lid covering a hollow space within the tiltable filter canister;
a handle connected to the lid, the handle rotatable between a first position and a second position;
wherein the handle forms a vacuum seal between the tiltable housing and the lid when in the first position and the handle positions the lid in a maintenance position when in the second position;
the handle connected to the lid by a first connection point and a second connection point, the first connection point and the second connection point disposed on opposite sides of the lid;
a first cam surface and a second cam surface located on the handle on opposite sides of the handle, the first cam surface and the second cam surface comprising a first recess and a second recess respectively;
wherein the first cam surface travels along the first connection point and the second cam surface travels along the second connection point when the handle is rotated between the first position and the second position;
a first stop and a second stop located on opposite sides of the tiltable housing, the first stop positioned to be received by the first recess of the first cam surface and the second stop positioned to be received by the second recess of the second cam surface when the handle is in the first position;
wherein the first cam surface engages a top portion of the first stop and the second cam surface engages a top portion of the second stop while the handle is rotated between the first position and the second position.

9. The filter canister of claim 8, further comprising a seal between the lid and the tiltable housing.

10. The filter canister of claim 9, further comprising a housing lip on a first side of the tiltable housing and a lid lip on a first side of the lid, the housing lip and the lid lip pressing the seal to form a vacuum tight seal when the handle is in the first position.

11. The filter canister of claim 8, wherein the connection point is a pin.

12. The filter canister of claim 1, further comprising a filter connection connected to the lid of the filter canister and a purge connection connected to the housing of the filter canister.

13. The filter canister of claim 12, further comprising a rotatable interconnection connecting the filter canister and the purge connection.

14. The filter canister of claim 13, wherein the tiltable housing is pivotable about the rotatable interconnection between a first housing position and a second housing position.

15. The filter canister of claim 13, wherein the rotatable interconnection is a quick disconnect fitting.

16. The filter canister of claim 1, further comprising an inlet for receiving a fluid to be filtered and an outlet for a filtered fluid to exit the filter canister.

17. A method of operation of a filter canister comprising:
moving a handle from a first position to a second position to break a vacuum tight seal between a tiltable housing and a lid disposed adjacent to the tiltable housing;
purging fluid from the filter canister;
lifting the handle to remove the lid from the tiltable housing;
adding a filtration media into an interior of the tiltable housing;
placing the lid on the filter canister;
moving the handle from the second position to the first position and forming a vacuum tight seal between the tiltable housing and the lid;
engaging a filtering operation and flowing a fluid into the filter canister.

18. The method of operating the filter canister of claim 17 further comprising:
tilting the filter canister about a rotatable interconnection from a first canister position to a second canister position;
replacing the filtration media in the interior of the tiltable housing;
tilting the filter canister from the second canister position to the first canister position;
re-engaging the filtering operation.

19. The method of operating the filter canister of claim 17 further comprising:
rotating a cam surface of the handle about a stop located on the tiltable housing until the stop is received by a recess of the cam surface when the handle is in the first position.

20. The method of operating the filter canister of claim 17 further comprising:
squeezing a seal between a housing lip located on the tiltable housing and a lid lip located on the lid when the handle is moving from the second position to the first position to form the vacuum tight seal between the tiltable housing and the lid.
